(19) United States
(12) Patent Application Publication
(10) Pub. No.: US 2017/0054837 A1
(43) Pub. Date: Feb. 23, 2017

(54) TERMINAL AND METHOD FOR DISPLAYING CALLER INFORMATION

(71) Applicant: Samsung Electronics Co., Ltd., Suwon-si (KR)

(72) Inventors: Hee-Youl CHOI, Hwaseong-si (KR); Yun-Hong MIN, Seoul (KR); In-Chul SONG, Suwon-si (KR); Paul Barom JEON, Seoul (KR)

(73) Assignee: Samsung Electronics Co., Ltd., Suwon-si (KR)

(21) Appl. No.: 15/346,102

(22) Filed: Nov. 8, 2016

Related U.S. Application Data
(63) Continuation of application No. PCT/KR2014/004186, filed on May 9, 2014.

(51) Int. Cl. H04M 1/56; H04M 1/725; G06K 9/00; H04M 3/436; G10L 15/08; G06T 7/00; H04M 3/42; H04M 3/428

(52) U.S. Cl. CPC H04M 1/56; H04M 3/42042; H04M 1/72569; H04M 3/4288; H04M 3/436; H04M 1/72583; G10L 15/08; G06T 7/004; G06K 9/00604; H04M 2250/12; H04M 2250/60; H04M 2201/40; G10L 2015/088; G06F 3/0488

(57) ABSTRACT

Disclosed are a terminal and a method for displaying caller information. A terminal for displaying caller information includes an incoming call notifier configured to output a notification of an incoming call, a user attention recognizer configured to recognize when the user pays attention to a display of the terminal, a display controller configured to determine the caller information to be displayed based on time elapsed from the notification of the incoming call to when the user pays attention to the display, and a call-waiting display configured to display the caller information.

### CROSS-REFERENCE TO RELATED APPLICATION(S)

This application claims the benefit under 35 U.S.C. §§111(a) and 363, and is a continuation of an International Application No. PCT/KR2014/004186 filed on May 9, 2014, the entire disclosure of which is incorporated herein by reference for all purposes.

### BACKGROUND

1. Field

The following description relates to displaying caller information on a call-waiting screen informing a user of an incoming call.

2. Description of Related Art

Recently, due to the dissemination of mobile phones, such as, mobile terminal, smart phone, and smart watch, communication has become more convenient regardless of time and place. Typically, a mobile phone includes a display and provides various communication-related functions. For example, the mobile phone provides a caller information display function, which is a function for displaying information related to a caller on a call-waiting screen and informs the user of an incoming call when the user is receiving a call from another caller. In an example, the information displayed information may include a variety of information, such as, for example, a phone number of the caller, a name of the caller, a call history such as a date at which a last call with the caller was performed, a message transmission, a message reception, a schedule, event information such as an anniversary date, and conversation content such as a memo.

In a phone including a display, a call-waiting screen informing of an incoming call is displayed for a short time before a user initiates the call. In an example, the user may not recognize the incoming call some time after a notification of an incoming call is initiated. In another example, the user may not pay attention to the call-waiting screen for some time after recognizing the notification of an incoming call. The caller information may be actually displayed for the user from a time in which the user pays attention to the call-waiting screen to a time in which the user initiates the call.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one general aspect, there is provided a terminal for displaying caller information, including a processor configured to generate a notification of an incoming call, recognize when a user pays attention to a display of the terminal, determine the caller information to be displayed based on a time elapsed from the notification of the incoming call to when the user pays attention to the display, and output the caller information.

A terminal may include an incoming call notifier configured to output a notification of the incoming call, a user attention recognizer configured to recognize when the user pays attention to the display of the terminal, a display controller configured to determine the caller information to be displayed based on the time elapsed from the notification of the incoming call to when the user pays attention to the display, and a call-waiting display configured to display the caller information.

The display controller may be configured to decrease the caller information to be displayed, in response to an increased in the time elapsed.

The display controller may be configured to gradually change the caller information to be displayed according to an increase or decrease of the time elapsed.

The display controller may be configured to change the caller information to be displayed according to a size of a call-waiting screen of the display.

The caller information may include call speech summary information generated by recognizing a previous conversation between the caller and the user and summarizing the previous conversation.

The call speech summary information may be generated by recognizing the previous conversation between the caller and the user using speech recognition automatically summarizing the previous conversation based on a keyword, and determining a priority for selection of the keyword included in the automatically summarized previous conversation.

The priority may be determined according to any one or any combination of a predefined standard for determining the priority according to a category of the keyword, or a selection command of the user input after displaying keyword of the automatically summarized previous conversation.

The call speech summary information may be generated by recognizing the previous conversation between the caller and the user using speech recognition automatically summarizing the previous conversation based on a theme discussed in the previous conversation.

The user attention recognizer me be configured to recognize that the user pays attention to the display using sensing data from a motion sensor sensing a movement of the terminal.

The user attention recognizer may be configured to recognize that the user pays attention to the display using an image of the user captured by a camera disposed on the same side of the terminal as the display.

The user attention recognizer may be configured to recognize that the user pays attention to the display using event sensing data of an event sensor, the event sensor being configured to sense an event in which the display is activated and an event in which another functions of a phone is activated.

The user attention recognizer may be configured to recognize that the user pays attention to the display by detecting a direction of a gaze of the user.

The user attention recognizer may be configured to recognize that the user pays attention to the display by detecting a touch of the user on a call-waiting screen of the display.

In another general aspect, there is provided a method for displaying caller information, including generating a notification of an incoming call, recognizing a user attention state in which a user pays attention to a display of a terminal, determining the caller information to be displayed on the display based on a time elapsed from the notification of the incoming call to the user attention state being recognized, and displaying the caller information.

The determining of the caller information may include decreasing the information to be displayed on the display, in response to an increase in the time elapsed.

The determining of the caller information may include gradually changing the caller information to be displayed, in response to according to an increase or decrease of the time elapsed.

The determining of the caller information may include changing the caller information according to a size of a call-waiting screen of the display.

The caller information may include call speech summary information generated by recognizing a previous conversation between the caller and the user using speech recognition and summarizing the previous conversation.

The call speech summary information may be generated by recognizing the previous conversation between the caller and the user using speech recognition, automatically summarizing the previous conversation based on a keyword, and determining a priority for selection of the keyword included in the automatically summarized previous conversation.

The priority may be determined according to any one or any combination of a predefined standard for determining the priority according to a category of the keyword, or the priority may be determined according to a selection command of the user input after displaying the keywords of the automatically summarized result to the user.

The method for displaying the caller information of claim 11, wherein the recognizing of the user attention state comprises recognizing that the user pays attention to the display using sensing data from a motion sensor sensing a movement of the terminal.

The recognizing of the user attention state may include recognizing that the user pays attention to the display using an image of the user captured by recognized a camera disposed on the same side of the terminal as the display.

The recognizing of the user attention state may include recognizing that the user pays attention to the display using event sensing data of an event sensor sensing an event in which the display is activated and an event in which another functions of a phone is activated.

In another general aspect, there is provided a digital device including an antenna, a cellular radio configured to transmit and receive data via the antenna according to a cellular communications standard, a touch-sensitive display, a memory configured to store instructions, and a processor configured to execute the instructions to detect an incoming call through the cellular radio, to generate a notification of the incoming call, to recognize when a user pays attention to the touch-sensitive display, to determine the caller information to be displayed based on a time elapsed from the notification of the incoming call to when the user pays attention to the touch-sensitive display, and to dynamically display the caller information on a call-waiting screen of the touch-sensitive display.

Other features and aspects will be apparent from the following detailed description, the drawings, and the claims.

### BRIEF DESCRIPTION OF DRAWINGS

FIG. 1 is a diagram illustrating an embodiment of a terminal for displaying caller information.

FIG. 2 is a diagram illustrating an example of a relation of an amount of caller information displayed on a call-waiting screen according to an elapsed time, i.e., from a time at which a notification of an incoming call is initiated to a time at which a user attention is recognized in a caller information display terminal.

FIG. 3 is a diagram illustrating an example of a relation of an amount of caller information displayed on a call-waiting screen according to an elapsed time, i.e., from a time at which a notification of an incoming call is initiated to a time at which a user attention is recognized in a caller information display terminal.

FIG. 4 is a diagram illustrating an example of a caller information provider included in a terminal for displaying caller information.

FIG. 5 is a diagram illustrating an example of a call speech summary information generator included in a caller information display terminal.

FIG. 6 is a diagram illustrating an embodiment of a terminal for displaying caller information.

FIG. 7 is a diagram illustrating an embodiment of a terminal for displaying caller information.

FIG. 8 is a diagram for describing an embodiment of a method for displaying caller information.

FIG. 9 is a diagram for describing an embodiment of a call speech summary information generation operation in a method for displaying caller information.

FIG. 10 is a diagram for describing an embodiment of a method for displaying caller information.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or apparatuses described herein. However, various changes, modifications, and equivalents of the methods, apparatuses, and/or apparatuses described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or apparatuses described herein that will be apparent after an understanding of the disclosure of this application.

A mobile phone such as a feature phone or a smart phone may include a display. A call-waiting screen of the mobile phone may include available space as well as a region for displaying information, such as, for example, a name of a caller, a phone number, and a date at which a last call was performed. The following description discloses methods and devices for displaying a variety of caller related information on a call-waiting screen. In some cases, it may not be efficient to display all information at one time on the call-waiting screen because a user may not have the time to read all the caller information displayed on the call-waiting screen.

For example, a caller has a tendency of abandoning the call when he or she feels that a notification of an incoming call lasts a very long time. The user of the phone sensitively responds to a time that a notification of an incoming call persists. For example, when much time does not pass after the notification of an incoming call starts ringing, the user may have time to slowly read information displayed on the call-waiting screen. In another example, when some amount of time passes after the notification of an incoming call starts ringing, the user may not have time to read the information displayed on the call-waiting screen.

A terminal and method for displaying caller information controls a display of caller information by adjusting an amount of caller information displayed on a call-waiting screen.

In an example, the terminal and method for displaying caller information adjusts the amount of caller information by recognizing a user attention state when displaying caller information on call-waiting screen. The “user attention” state refers to a state in which a user pays attention to a display of a phone, i.e., a state in which the user sees the display of the phone after recognizing an incoming call.

In an example, the terminal and method for displaying caller information changes the amount of caller information to be inversely proportional to an elapsed time, which is a time between an arrival of a call and the recognition of user attention.

In an example, when the user sees the call-waiting screen soon after a call is received, the user may have time to read all the caller information displayed, even when a large amount of caller information is displayed on the call-waiting screen. In this case, the large amount of caller information may be displayed in detail. In another example, when the user sees the call-waiting screen after the call is received from the caller and a long time passes, the user may not have time to read all the information displayed on the call-waiting screen. In this case, a small amount of caller information may be briefly displayed.

In an example, the terminal and method for displaying caller information adjusts an amount of caller information according to a size of a call-waiting screen.

In some smart phones, a size of the call-waiting screen may be constant. In other phones providing various screen sizes, such as a tablet device, the size of the call-waiting screen may not be the same at all times. In another example, when one or more phone applications are installed in a smart phone, the installed applications may have different call-waiting screens. Accordingly, when adjusting an amount of caller information, the amount of caller information may be adjusted according to a size of the call-waiting screen obtained by sensing the size of the call-waiting screen.

The terminal and method for displaying caller information adjusts an amount of call speech summary information summarized by recognizing previous call speech between a caller and a user on a call-waiting screen. In an example, the call speech summary information is information generated by summarizing speech by each the caller and the user in a previous call between the caller and the user. The call speech summary information may be obtained by briefly summarizing a theme discussed in the previous call with the caller, and may be shown to the user.

Hereinafter, in an example, the terminal and method for displaying caller information is described with reference to a smart phone. However, the smart phone is a non-exhaustive example, and it should be understood that the terminal and method for displaying caller information may be embedded in or interoperate with various digital devices such as, for example, a mobile phone, a cellular phone, a personal computer (PC), a laptop, a notebook, a subnotebook, a netbook, or an ultra-mobile PC (UMPC), a tablet personal computer (tablet), a phablet, a mobile internet device (MID), a personal digital assistant (PDA), an enterprise digital assistant (EDA), a digital camera, a digital video camera, a portable game console, an MP3 player, a portable/personal multimedia player (PMP), a handheld e-book, an ultra mobile personal computer (UMPC), a portable lab-top PC, a global positioning system (GPS) navigation, a personal navigation device or portable navigation device (PND), a handheld game console, an e-book, and devices such as a high definition television (HDTV), an optical disc player, a DVD player, a Blue-ray player, a setup box, robot cleaners, a home appliance, content players, communication systems, image processing systems, graphics processing systems, other consumer electronics/information technology (CE/IT) device, or any other device capable of wireless communication or network communication consistent with that disclosed herein. The digital devices may be may be embedded in or interoperate with a smart appliance, an intelligent vehicle, an electric vehicle, a hybrid vehicle, a smart home environment, or a smart building environment.

The digital devices may also be implemented as a wearable device, which is worn on a body of a user. In one example, a wearable device may be self-mountable on the body of the user, such as, for example, a ring, a watch, a pair of glasses, glasses-type device, a bracelet, an ankle bracket, a belt, a necklace, an earring, a headband, a helmet, a device embedded in the cloths, or as an eye glass display (EGD), which includes one-eyed glass or two-eyed glasses. In another non-exhaustive example, the wearable device may be mounted on the body of the user through an attaching device, such as, for example, attaching a smart phone or a tablet to the arm of a user using an armband, incorporating the wearable device in a cloth of the user, or hanging the wearable device around the neck of a user using a lanyard.

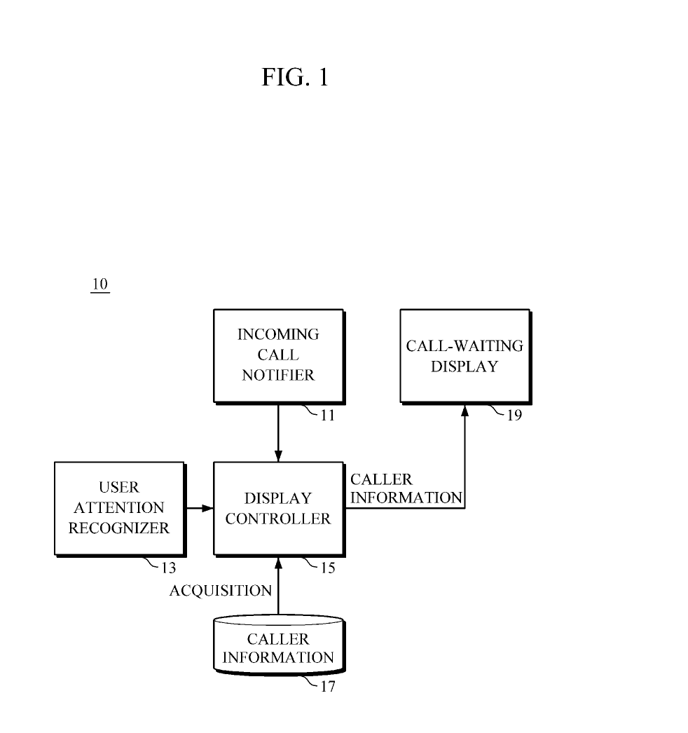

FIG. 1 is a diagram illustrating an embodiment of a terminal for displaying caller information. FIG. 1 illustrates a terminal for displaying caller information 10, which recognizes that a user pays attention to a display after a call arrives and adjusts an amount of caller information according to an elapsed time to display the caller information on a call-waiting screen.

In an example, the terminal for displaying caller information 10 includes an incoming call notifier 11, a user attention recognizer 13, a display controller 15, a caller information 17, a call-waiting display 19. While components related to the present example are illustrated in the displaying caller information 10 of FIG. 1, it is understood that those skilled in the art may include other general components.

In an example, the incoming call notifer 11 outputs a notification of an incoming call by sound, sight, or vibration when a call is received from a caller. The incoming call notifier 11 may include a speaker and/or a vibration device for outputting the notification of an incoming call. For example, the incoming call notifier 11 acoustically represents the arrival of the call to the user by outputting a notification of an incoming call sound. In another example, the incoming call notifier 11 allows the user to feel a vibration of the smart phone using a piezoelectric vibration device included in the smart phone. After the notification of an incoming call is initiated, the notification may last until the user inputs a call initiation command through the smart phone in order to initiate the call or until the caller abandons the call.

In an example, the user attention recognizer 13 recognizes a user attention state in which the user pays attention to a display of the phone. The user attention recognizer 13 recognizes the user attention state by determining a state in which the user sees the display when a predefined movement of the smart phone or an event generated in the smart phone is sensed.

For example, when the user recognizes the notification of an incoming call or the vibration and takes the smart phone out of a pocket from inside their clothing and places the smart phone in front of the user's face, a state in which the user holds the smart phone by hand and makes the smart phone face the user's face may be the user attention state. Accordingly, the user attention state may be sensed by sensing the movement of the smart phone sensed from a motion sensor such as, for example, an acceleration sensor included in the smart phone.

As another example, when there is an incoming call while the user plays a game on the smart phone, the user may be determined as already being in the state of paying attention to the display. Accordingly, the user attention state may be recognized by sensing an event in which the display is activated by a specific function of the smart phone being activated.

As another example, assume that an incoming call rings when the user drafts a document while paying attention to a desktop computer screen in a state in which the user has put the smart phone on a desk. In this case, the user may make the smart phone face the user's face by turning the user's head. Accordingly, the user attention state may be recognized by recognizing that the user's face is in front of the display. In another example, the user attention state may be recognized by recognizing a direction of an eye (that is, a gaze) of the user.

In another example, when the notification of an incoming call rings when the user drafts the document while paying attention to the desktop computer screen in the state in which the user has put the smart phone on the desk, the user may push or pull the smart phone so that the display faces the user's face by touching the smart phone on the desk using the user's finger. Accordingly, the user attention state may be recognized by sensing that the smart phone is touched and/or moved.

The display controller 15 may dynamically control an amount of the caller information that is displayed on the display based on an elapsed time, which is a time until the user attention state is recognized.

In an example, the “elapsed time” refers to a time from when a notification of an incoming call is initiated to a time when the user attention state is recognized. For example, when there is an incoming call while making a memo using the smart phone, the user may see the display as soon as the incoming call notification is received on the phone. In another example, when the user moves by subway in a state in which the user has put the smart phone into a bag, the user may see the display when some amount of time passes after the notification of an incoming call is initiated. As such, the elapsed time taken until the user attention state is recognized may change according to a situation of the user.

When the elapsed time is small, the user may expect that the caller will wait for a certain time without abandoning the call. Accordingly, the user may have time to read information displayed on the call-waiting screen. On the other hand, when the elapsed time is great, the user may expect that the caller will soon abandon the call. Accordingly, the user may not have time to read all the information displayed on the call-waiting screen.

In an example, the display controller 15 considers the situation of the user at a time at which the call is received even when the call is received from the same caller. For example, when the elapsed time taken until the user pays attention to the display is small, the display controller 15 may determine that an amount of caller information which fills the entire call-waiting screen is to be displayed on the call-waiting screen. In another example, when the elapsed time taken until the user pays attention to the display is great, the display controller 15 may determine that an amount of caller information which fills only a portion of the call-waiting screen is to be displayed on the call-waiting screen.

The caller information 17 may include a variety of caller information such as, for example, caller identification information such as a phone number, a name, picture, alias, included in a phone number list, previous call history information included in call history information, and call speech information generated through a speech recognition function.

When an amount of information to be displayed on the call-waiting screen is determined according to the elapsed time by the display controller 15, the caller information to be displayed in caller information which is previously stored in the caller information 17 may be obtained. The obtained caller information may be transmitted to the call-waiting display 19 by the display controller 15.

In an example, the call-waiting display 19 displays the call-waiting screen on the display from a time at which the user pays attention to the display to a time at which the user initiates the call. The caller information corresponding to the amount of information determined by the display controller 15 may be displayed on the call-waiting screen.

An example in which caller information to be displayed on the call-waiting display 19 is obtained by the display controller 15 and the obtained caller information is transmitted to the call-waiting display 19. In another example, the display controller 15 transmits data related to the determined amount of information to the call-waiting display 19 and the call-waiting display 19 obtains the caller information to be displayed from the caller information 17.

As described above, the terminal for displaying caller information 10 shown in FIG. 1 may recognize that the user pays attention to the display after the arrival of a call and intelligently display the caller information by differentiating whether the user has time to read the call-waiting screen.

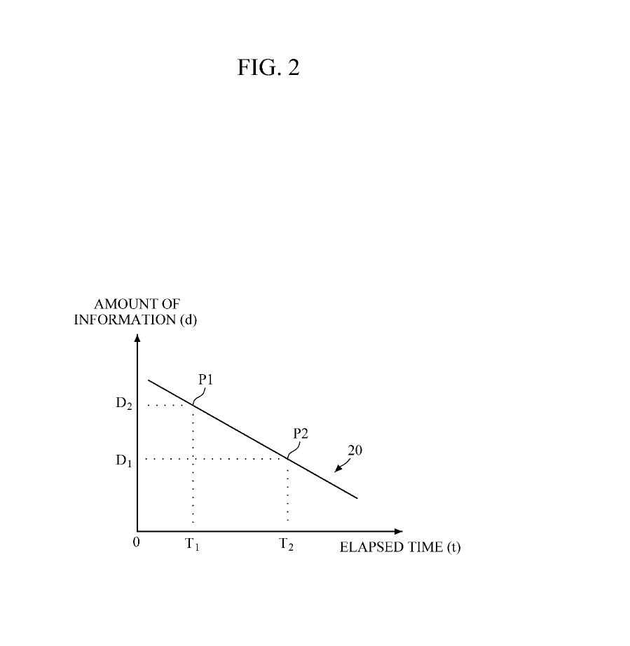

FIG. 2 is a diagram illustrating an example of a relation of an amount of caller information displayed on a call-waiting screen according to an elapsed time, i.e., from a time at which a notification of an incoming call is initiated to a time at which a user attention is recognized in a terminal for displaying caller information.

Referring to FIG. 2, a graph 20 showing that an elapsed time t and an amount of information d have an inverse relationship is illustrated. The amount of information d is D2 when the elapsed time t is T1, the amount of information d is D1 when the elapsed time t is T2, and generally, the amount of information to be displayed may be decreased when the elapsed time is increased.

The graph 20 is shown in the form of a continuous line. However, since the information to be displayed on the call-waiting screen includes a word, a phrase, a sentence, or the like, it may be desirable to actually divide the amount of information to be displayed into several steps.

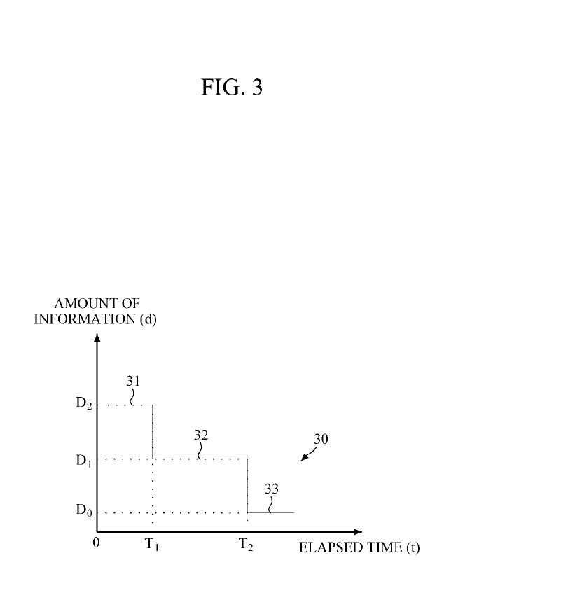

FIG. 3 is a diagram illustrating an example of a relation of an amount of caller information displayed on a call-waiting screen according to an elapsed time, i.e., from a time at which a notification of an incoming call is initiated to a time at which a user attention is recognized in a terminal for displaying caller information.

Referring to FIG. 3, a graph 30 illustrates that the elapsed time t and the amount of information d have an inverse relationship having three steps 31, 32, and 33. The amount of information d may be D2 when the elapsed time t is a period which is between 0 to T1, and a large amount of caller information may be displayed on the call-waiting screen. The amount of information d may be D0 when the elapsed time t is T2 or more, and in this case, a small amount of information (for example, only one third of the screen or only a name and a phone number of a caller) may be displayed on the call-waiting screen.

Although the relationship between the elapsed time t and the amount of information d is illustrated as an example having the three steps 31, 32, and 33 in FIG. 3, the relationship is not limited thereto. For example, the relationship between the elapsed time t and the amount of information d may be set to have two or four or more steps.

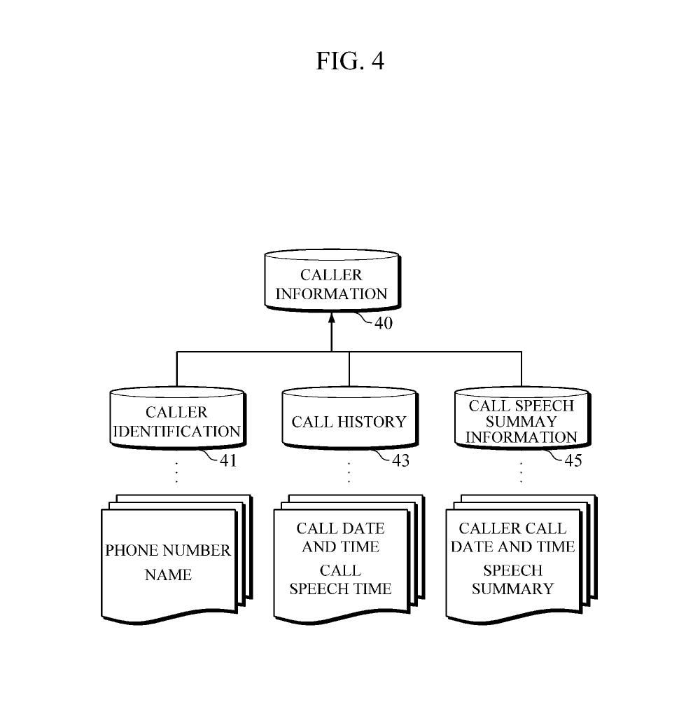

FIG. 4 is a diagram illustrating an example of a caller information provider included in a terminal for displaying caller information.

Referring to FIG. 4, in an example, caller information 40 may correspond to the caller information 17 of the terminal for displaying the caller information shown in FIG. 1. In an example, the caller information included in the caller information 40 include a identification information 41, a call history 43, and call speech summary information 45.

In an example, the identification information 41 includes a phone number and a name of each of the callers, and information of various items such as a picture, an address, an office, a memo, as personal information of each of the callers. The call history 43 may include data such as a previous call date and time or call speech time between each caller and the user. The call history 43 may be automatically generated whenever a call is generated.

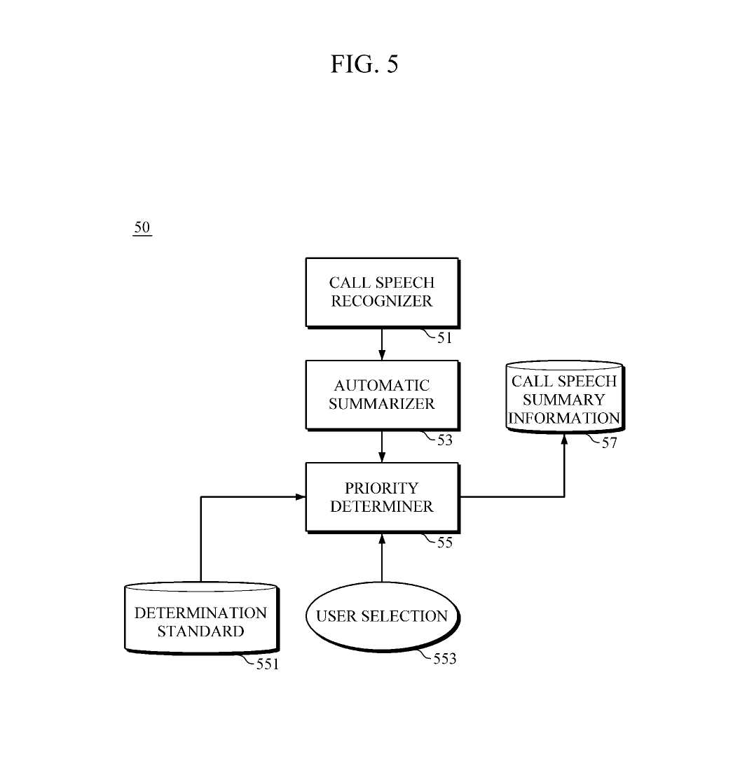

The call speech summary information 45 may automatically convert call speech in a previous call between each caller and the user into text, and may include the summarized text information. The call speech summary information 45 may be automatically generated whenever each call is generated. In an example, the call speech summary information 45 may include history and context concerning other interactions between the caller and the user, such as, for example, text exchanged between the caller and the user, social media interaction between the caller and the user. The generation of the call speech summary information 45 will be described in more detail with reference to FIG. 5.

FIG. 5 is a diagram illustrating an example of a call speech summary information generator included in a terminal for displaying caller information.

Referring to FIG. 5, a call speech summary information generator 50 for generating call speech summary information described with reference to FIGS. 1 to 4 is illustrated. The call speech summary information generator 50 is capable of configuring pieces of the caller information of the terminal for displaying the caller information. In an example, the call speech summary information generator 50 includes a call speech recognizer 51, an automatic summarizer 53, and a priority determiner 55.

The call speech recognizer 51 converts a conversation between the caller and the user into text when a call is initiated and for storing the converted text. Recording call speech is not optimal as large storage capacity is needed to store voice data. In an example, the conversation between the caller and the user is converted into text using the conventional speech recognition or dictation method.

The call speech text may be summarized using an automatic summarization method because it may not be efficient to display all the call speech text on the call-waiting screen. The automatic summarizer 53 may summarize the call speech text generated by the call speech recognizer 51 using a method of automatic summarization.

In an example, the automatic summarization method may be a method such as, a document summarization method, an automatic document summarization method, for example. In an example, the automatic summarization method is divided into an extraction method and an abstraction method. The extraction method is a method of extracting a keyword, a phrase, and a sentence included in an original text. The abstraction method is a method of constructing internal semantic expressions and summarizing them by generating a summary using a natural language generation method. In some ways, the abstraction method is similar to a method in which a human summarizes. In an example, an automatic summarization method may be used without limitation.

The priority determiner 55 determines priorities of keywords such as a word, a phrase, a sentence, and the like included in the call speech summary information generated by the automatic summarizer 53. In an example, the automatically summarized call speech summary information includes a plurality of keywords. The keywords may be classified as being selected or not being selected according to the amount of information that is displayed. For example, keywords having the highest priority may be selected to be displayed even when the amount of information to be displayed on the call-waiting screen is the smallest. Keywords having the smallest priority may be selected to be displayed only when the amount of information to be displayed on the call-waiting screen is the greatest.

The priority determiner 55 may determine a priority according to a predefined determination standard 551. In an example, the determination of the priority may be automatic. In an example, the determination standard 551 includes a standard in which a priority is increased as the frequency of the same key word is increased. In an example, the determination standard 551 includes a standard in which a keyword representing a place and a time has a high priority. In another example, the determination standard 551 may determine a priority according to an accent, representing emphasis, in the call speech information. In an example, the standard may be predefined and stored.

In another method, the priority determiner 55 may determine a priority according to user selection 553. In an example, the priority determiner 55 may include a means of displaying the keywords included in the information generated by the automatic summarizer 53 on the display, and allowing the user to select the priority of the keywords. When the user inputs a selection, the priority determiner 55 may determine priorities of the keywords according to the selection of the user, and may include the determined priority of the keywords in the call speech summary information 57.

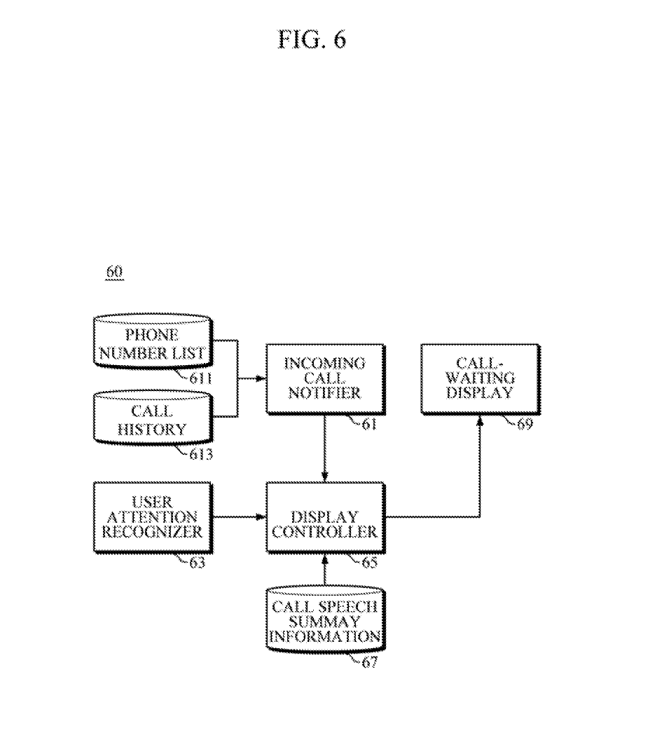

FIG. 6 is a diagram illustrating an embodiment of a terminal for displaying caller information. FIG. 6 illustrates a terminal for displaying caller information 60, which recognizes that a user pays attention to a display after an arrival of a call. The terminal for displaying caller information 60 adjusts an amount of a previous conversation between a caller and the user according to an elapsed time to display the previous conversation. In an example, the terminal for display the caller information 60 includes components, such as, an incoming call notifier 61, a user attention recognizer 63, a display controller 65, call speech summary information 67, and a call-waiting display 69.

Like the incoming call notifier 11 shown in FIG. 1, the incoming call notifier 61 outputs a notification of an incoming call by sound, sight, or vibration when a call is received from a caller in a phone.

In an example, the incoming call notifier 61 identifies the caller by searching for a phone number and a call history of the caller, and transmits the identified caller to the display controller 65. For example, the incoming call notifier 61 may identify the caller by searching through a phone number list 611 and a call history 613 which are previously stored. Accordingly, the incoming call notifier 61 outputs a notification using different call arrival sounds which are previously stored corresponding to the identified caller. In this case, the user recognizes that a call is received from a previously known caller. In an example, the incoming call notifier 61 transmits caller identification information together with start time information of the notification of an incoming call to the display controller 65.

Like the user attention recognizer 13 shown in FIG. 1, the user attention recognizer 63 recognizes a user attention state in which the user pays attention to the display of the phone. The user attention recognizer 63 monitors a smart phone when the notification of an incoming call is initiated. The user attention recognizer 63 may recognize the user attention state by determining a state in which the user sees the display when a predefined movement of the smart phone or an event generated in the smart phone is sensed. The user attention recognizer 63 transmits information of a time at which the user attention state is recognized to the display controller 65.

Like the display controller 15 shown in FIG. 1, the display controller 65 may dynamically control an amount of caller information, such as, the call speech summary information 67, that is displayed on the display based on an elapsed time taken until the user attention state is recognized.

The call speech summary information 67 may be the call speech summary information 57 described above with reference to FIG. 5.

Like the call-waiting display 19 shown in FIG. 1, the call-waiting display 69 displays the call-waiting screen on the display from a time at which the user pays attention to the display to a time at which the user initiates the call. The call speech summary information corresponding to an amount of information determined by the display controller 15 may be displayed.

FIG. 6 illustrates an example in which the caller identification information is transmitted from the incoming call notifier 61 to the display controller 65. In an example, the incoming call notifier 61 may have a configuration in which only a phone number of the caller is transmitted to the display controller 65. In this case, the call speech summary information 67 may include corresponding call speech summary information together with the caller identification information, such as, the phone number of the caller.

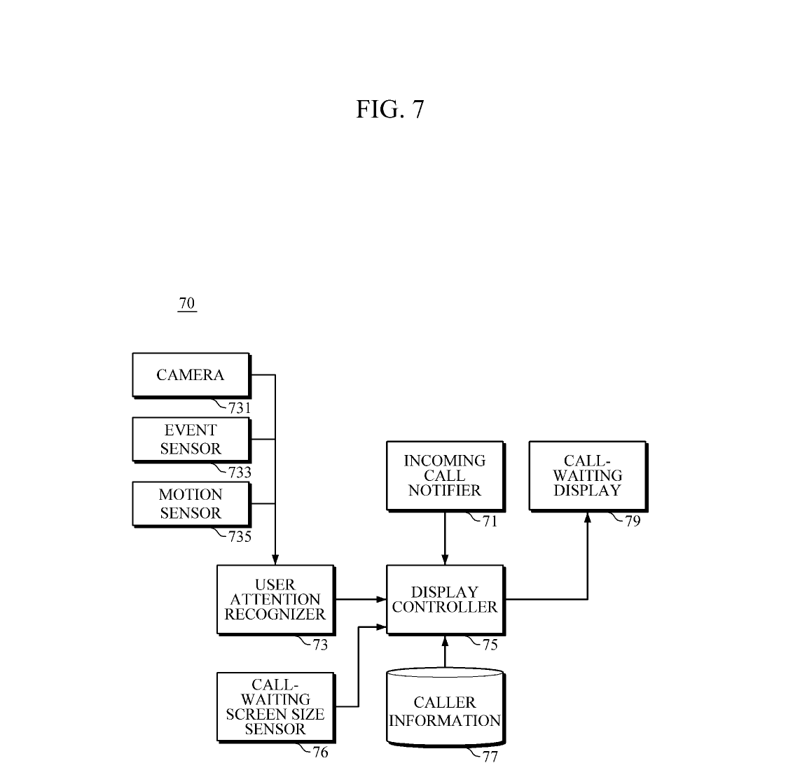

FIG. 7 is a diagram illustrating an embodiment of a terminal for displaying caller information. Referring to FIG. 7, a terminal for displaying caller information 70 is illustrated. The terminal for displaying caller information 70 recognizes that a user pays attention to a display after arrival of a call using various means. The terminal for displaying caller information 70 adjusts an amount of a previous conversation between a caller and the user according to an elapsed time and/or a size of a call-waiting screen to display the previous conversation. In an example, the terminal for displaying the caller information 70 includes an incoming call notifier 71, a user attention recognizer 73, a display controller 75, a call-waiting screen size sensor 76, a caller information 77, and a call-waiting display 79.

Like the incoming call notifier 11 shown in FIG. 1, the incoming call notifier 71 outputs a notification of an incoming call by sound, sight, or vibration when a call is received from a caller in a phone.

Like the user attention recognizer 13 shown in FIG. 1, the user attention recognizer 73 recognizes a user attention state in which the user pays attention to a display of the phone. The user attention recognizer 73 monitors a smart phone when the notification of an incoming call is initiated. While monitoring the smart phone, the user attention recognizer 73 recognizes the user attention state by determining a state in which the user sees the display when a predefined movement of the smart phone or an event generated in the smart phone is sensed. The user attention recognizer 73 transmits information of a time at which the user attention state is recognized to the display controller 75.

In the example shown, the user attention recognizer 73 includes a camera 731, an event sensor 733, and a motion sensor 735. In an example, the camera recognizes whether the user's face is in front of the display. In an example, the user attention state is recognized when the face of the user is recognized. The event sensor 733 senses an event in which another function of the smart phone is activated upon the arrival of the call. For example, the user attention state may be recognized when a user interacts with the smart phone through a touch input means of the display. The motion sensor 735 such as, for example, an acceleration sensor or a gyro sensor, is capable of sensing a movement of the smart phone. For example, the user attention state may be recognized when the smart phone is touched and a slight movement of the smart phone is sensed after the notification of an incoming call is initiated while the smart phone is maintained to be horizontal.

The call-waiting screen size sensor 76 may senses a size of the call-waiting screen to be displayed by the call-waiting display 79. The call-waiting screen size sensor 76 may adjust an amount of caller information to be displayed according to the size of the call-waiting screen. For example, the smart phone including only one application providing a phone function may provide the call-waiting screen having a constant size. In this case, the call-waiting screen size sensor 76 may obtain the size of the call-waiting screen from an operating system of the smart phone or the application executing the phone function. In another example, a device providing a multi-application environment and/or a multi-interface environment may have different sizes of the call-waiting screen for every application providing the phone function or for every window. In this case, the call-waiting screen size sensor 76 may obtain the size of the call-waiting screen from the operating system of the device or an application which is currently activated. Size information of the call-waiting screen sensed by the call-waiting screen size sensor 76 may be transmitted to the display controller 75.

Like the display controller 15 shown in FIG. 1, the display controller 75 may dynamically control an amount of the caller information of the caller information 77 that is displayed on the display based on an elapsed time taken until the user attention state is recognized.

Further, the display controller 75 may dynamically control the amount of the caller information to be displayed based on not only the elapsed time taken until the user attention state is recognized but also the size information of the call-waiting screen.

Like the call-waiting display 19 shown in FIG. 1, the call-waiting display 79 displays a call-waiting screen including caller information on the display from a time at which the user pays attention to the display to a time at which the user initiates the call. In an example, only the amount of information determined by the display controller 75 of the caller information included in the call-waiting screen is displayed.

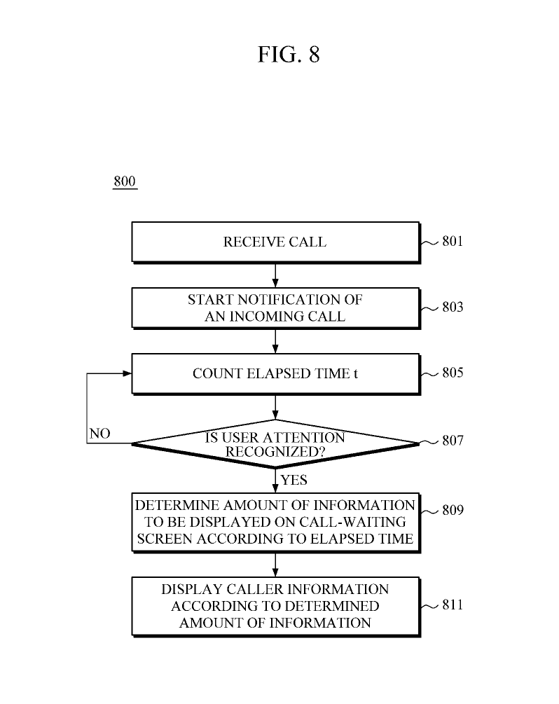

FIG. 8 is a diagram for describing one embodiment of a method for displaying caller information. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. In addition to the description of FIG. 8 below, the above descriptions of FIGS. 1-7, are also applicable to FIG. 8, and are incorporated herein by reference. Thus, the above description may not be repeated here.

Referring to FIG. 8, in 801, in a method for displaying caller information 800 a call is received from a caller in a phone.

In 803, the incoming call from the caller may initiate a notification of the incoming call by sound, sight, or vibration using a speaker, display, or a vibration device.

In 805, when the notification of the incoming call is initiated, the elapsed time t is continuously counted until the user attention state is recognized. In an example, the user attention state in which the user pays attention to a display is recognized using data sensed by a camera, an event recognizer, or a motion sensor included in the smart phone.

In 807, when the user attention state is not recognized by a processor of the smart phone (NO of 807), the elapsed time t may be continuously counted. In 807, the counting of the elapsed time t is stopped when the user attention state is recognized (YES of 807). Further, the counting of the elapsed time t is stopped when the caller abandons and disconnects the call.

When the user attention state is recognized (YES of 807), the elapsed time is determined. In 809, an amount of information to be displayed on the call-waiting screen may be determined according to the elapsed time. In an example, a relationship between the elapsed time and the amount of information to be displayed is determined as described above with reference to FIG. 3. In an example, as the elapsed time t is increased, the amount of information d may be decreased in three steps. Referring to FIG. 3, in a time period of 0 to T1 in which the elapsed time t is relatively small, the amount of information d to be displayed on the call-waiting screen may be determined to be a relatively large amount of D2. In a time period, which is T2 or more, in which the elapsed time t is relatively great, the amount of information d to be displayed on the call-waiting screen may be determined to be a relatively small amount of D0.

In 811, after the amount of information is determined, the selected or obtained caller information is displayed on the call-waiting screen of the smart phone.

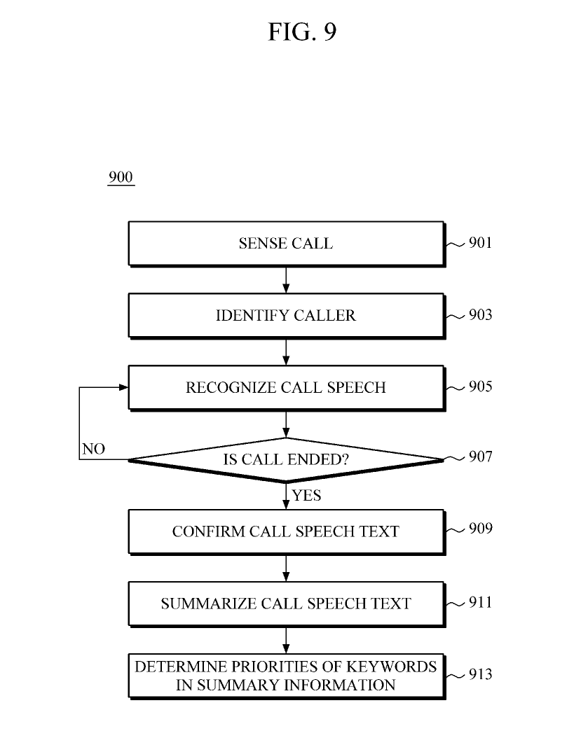

FIG. 9 is a diagram for describing an embodiment of a call speech summary information generation operation in a method for displaying caller information. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. In addition to the description of FIG. 9 below, the above descriptions of FIGS. 1-8, are also applicable to FIG. 9, and are incorporated herein by reference. Thus, the above description may not be repeated here.

Referring to FIG. 9, in 901, a call speech summary information generation operation 900 starts by sensing that a call between a caller and a user is performed when a phone function of a smart phone is activated.

In 903, the caller is identified and identification information of speakers, i.e., the caller and the user is obtained.

In 905, a conversation between the caller and the user, i.e., the call speech, is recognized by a speech recognition module. A call speech recognition operation is continued until the call is ended (YES of 907).

In 909, when the call ends, the call speech recognition operation ends, speech text generated by the call speech recognition operation may be confirmed.

In 911, the speech text is summarized. In an example, the summarization is automatic.

In 913, priorities of keywords such as, for example, a word, a phrase, a sentence, included in summary information of the speech text is determined. In an example, the priorities of keywords is stored as caller information.

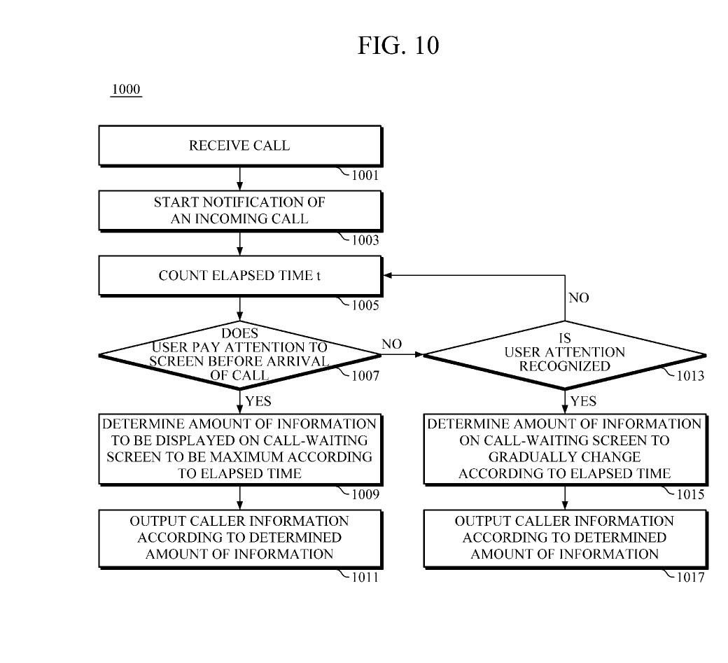

FIG. 10 is a diagram for describing an embodiment of a method for displaying caller information. The operations in FIG. 10 may be performed in the sequence and manner as shown, although the order of some operations may be changed or some of the operations omitted without departing from the spirit and scope of the illustrative examples described. Many of the operations shown in FIG. 10 may be performed in parallel or concurrently. In addition to the description of FIG. 10 below, the above descriptions of FIGS. 1-9, are also applicable to FIG. 10, and are incorporated herein by reference. Thus, the above description may not be repeated here.

Referring to FIG. 10, in 1001, a method for displaying caller information 1000 starts from an incoming call reception operation in which a call is received from a caller in a phone.

In 1003, the incoming call from the caller initiates a notification of the incoming call by sound, sight, or vibration by a speaker, display, or a vibration device, respectively.

In 1005, when the notification of the incoming call is initiated, the elapsed time t of the call is counted. In an example, a counting operation of the elapsed time t is continuously performed until the user attention is recognized. In an example, the user attention state in which the user pays attention to a display is recognized using data sensed by a camera, an event recognizer, a motion sensor included in the smart phone.

In 1007, a determination is made regarding whether the user activates another function of the smart phone and pays attention to the display screen before the arrival of the call. The determination of whether the user pays attention to the screen before the arrival of the call is made by a component, such as, an event sensor. In an example, the sensing of of whether the user pays attention to the screen is sensed together with the arrival of the call. If it is determined that the user pays attention to the screen before the arrival of the call, (YES of 1007), the elapsed time may be determined to be minimal and an amount of caller information to be displayed on the call-waiting screen may be determined to be maximal in 1009. In 1011, a call-waiting screen including a maximum amount of caller information is displayed.

If it is determined that the user does not pay attention to the screen before the arrival of the call (NO of 1007), in 1013, the user attention state is recognized using a sensor, such as, for example, motion sensor or the camera. When the user attention state is not sensed (NO of 1013), the elapsed time is continuously counted. When the user attention state is sensed (YES of 1013), the counting of the elapsed time is stopped and the elapsed time is confirmed. In 1015, an amount of the caller information to be displayed on the call-waiting screen may be determined according to the confirmed elapsed time, for example, in the stepped manner shown in FIG. 3. For example, in 1017, a call-waiting screen including an intermediate amount or a minimum amount of the caller information is displayed.

In an example, the terminal for displaying the caller information is implemented by a combination of components such as, a processor, a memory, a user input device, and a presentation device. In an example, the user input device facilitates inputting of instructions for allowing the processor to perform a specific task or data needed for performing the specific task. In an example, the user input device includes a physical or virtual keyboard or keypad, a key button, a mouse, a joystick, a track ball, a touch-sensitive input means, and a microphone. In an example, the presentation device includes one or more hardware components that provide the ability to render a user interface and/or receive user input. The presentation device can encompass any combination of display region, gesture capture region, a touch sensitive display, and/or a configurable area. The presentation device can be embedded in the hardware or may be an external peripheral device that may be attached and detached from the apparatus. The presentation device or user input device may be a single-screen or a multi-screen display or input. A single physical screen can include multiple displays that are managed as separate logical displays permitting different content to be displayed on separate displays although part of the same physical screen. In an example, the presentation device is a printer, a speaker, or a vibration device.

Disclosed are terminal and method for displaying caller information which recognizes that a user pays attention to a call-waiting screen after a notification of an incoming call is initiated and adjusts an amount of caller information displayed on the call-waiting screen according to time elapsed from when the notification of an incoming call is initiated to a time when the user attention is recognized.

Disclosed are terminal and method for displaying call information by recognizing that a user pays attention to a call-waiting screen after a notification of an incoming call is initiated, and adjusting an amount of caller information displayed on the call-waiting screen according to an elapsed time from when the notification of an incoming call is initiated to when the user attention is recognized. Thus, information related to a caller is displayed to be efficiently recognized by a user during a time before the user initiates the call.

The terminal for displaying caller information 10, incoming call notifier 11, user attention recognizer 13, display controller 15, caller information 17, caller information 40, identification information 41, call history 43, call speech summary information 45, call speech summary information generator 50, call speech recognizer 51, automatic summarizer 53, priority determiner 55, call speech summary information 57, determination standard 551, caller information 60, incoming call notifier 61, user attention recognizer 63, display controller 65, call speech summary information 67, event sensor 733, terminal for displaying the caller information 70, incoming call notifier 71, user attention recognizer 73, display controller 75, call-waiting screen size sensor 76, and caller information 77 described in FIGS. 1 and 4-7 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 8-10 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A terminal for displaying caller information, comprising:
a processor configured to:
generate a notification of an incoming call;
recognize when a user pays attention to a display of the terminal;
determine the caller information to be displayed based on a time elapsed from the notification of the incoming call to when the user pays attention to the display; and
output the caller information.

2. The terminal for displaying caller information of claim 1, wherein the processor comprises:
an incoming call notifier configured to output a notification of the incoming call;
a user attention recognizer configured to recognize when the user pays attention to the display of the terminal;
a display controller configured to determine the caller information to be displayed based on the time elapsed from the notification of the incoming call to when the user pays attention to the display; and
a call-waiting display configured to display the caller information.

3. The terminal for displaying the caller information of claim 2, wherein the display controller is further configured to decrease the caller information to be displayed, in response to an increased in the time elapsed.

4. The terminal for displaying the caller information of claim 3, wherein the display controller is further configured to gradually change the caller information to be displayed according to an increase or decrease of the time elapsed.

5. The terminal for displaying the caller information of claim 4, wherein the display controller is further configured to change the caller information to be displayed according to a size of a call-waiting screen of the display.

6. The terminal for displaying the caller information of claim 2, wherein the caller information comprises call speech summary information generated by recognizing a previous conversation between the caller and the user and summarizing the previous conversation.

7. The terminal for displaying the caller information of claim 6, wherein the call speech summary information is generated by recognizing the previous conversation between the caller and the user using speech recognition automatically summarizing the previous conversation based on a keyword, and determining a priority for selection of the keyword included in the automatically summarized previous conversation.

8. The terminal for displaying the caller information of claim 7, wherein the priority is determined according to any one or any combination of a predefined standard for determining the priority according to a category of the keyword, or a selection command of the user input after displaying keyword of the automatically summarized previous conversation.

9. The terminal for displaying the caller information of claim 6, wherein the call speech summary information is generated by recognizing the previous conversation between the caller and the user using speech recognition automatically summarizing the previous conversation based on a theme discussed in the previous conversation.

10. The terminal for displaying the caller information of claim 2, wherein the user attention recognizer is further configured to recognize that the user pays attention to the display using sensing data from a motion sensor sensing a movement of the terminal.

11. The terminal for displaying the caller information of claim 2, wherein the user attention recognizer is further configured to recognize that the user pays attention to the display using an image of the user captured by a camera disposed on the same side of the terminal as the display.

12. The terminal for displaying the caller information of claim 2, wherein the user attention recognizer is further configured to recognize that the user pays attention to the display using event sensing data of an event sensor, the event sensor being configured to sense an event in which the display is activated and an event in which another functions of a phone is activated.

13. The terminal for displaying the caller information of claim 2, wherein the user attention recognizer is further configured to recognize that the user pays attention to the display by detecting a direction of a gaze of the user.

14. The terminal for displaying the caller information of claim 2, wherein the user attention recognizer is further configured to recognize that the user pays attention to the display by detecting a touch of the user on a call-waiting screen of the display.

15. A method for displaying caller information, comprising:
generating a notification of an incoming call;
recognizing a user attention state in which a user pays attention to a display of a terminal;
determining the caller information to be displayed on the display based on a time elapsed from the notification of the incoming call to the user attention state being recognized; and
displaying the caller information.

16. The method for displaying the caller information of claim 15, wherein the determining of the caller information comprises decreasing the information to be displayed on the display, in response to an increase in the time elapsed.

17. The method for displaying the caller information of claim 16, wherein the determining of the caller information comprises gradually changing the caller information to be displayed, in response to according to an increase or decrease of the time elapsed.

18. The method for displaying the caller information of claim 17, wherein the determining of the caller information comprises changing the caller information according to a size of a call-waiting screen of the display.

19. The method for displaying the caller information of claim 15, wherein the caller information comprises call speech summary information generated by recognizing a previous conversation between the caller and the user using speech recognition and summarizing the previous conversation.

20. The method for displaying the caller information of claim 19, wherein the call speech summary information is generated by recognizing the previous conversation between the caller and the user using speech recognition, automatically summarizing the previous conversation based on a keyword, and determining a priority for selection of the keyword included in the automatically summarized previous conversation.

21. The method for displaying the caller information of claim 20, wherein the priority is determined according to any one or any combination of a predefined standard for determining the priority according to a category of the keyword, or
the priority is determined according to a selection command of the user input after displaying the keywords of the automatically summarized result to the user.

22. The method for displaying the caller information of claim 15, wherein the recognizing of the user attention state comprises recognizing that the user pays attention to the display using sensing data from a motion sensor sensing a movement of the terminal.

23. The method for displaying the caller information of claim 15, wherein the recognizing of the user attention state comprises recognizing that the user pays attention to the display using an image of the user captured by recognized a camera disposed on the same side of the terminal as the display.

24. The method for displaying the caller information of claim 15, wherein the recognizing of the user attention state comprises
recognizing that the user pays attention to the display using event sensing data of an event sensor sensing an event in which the display is activated and an event in which another functions of a phone is activated.

25. A non-transitory computer-readable storage medium storing instructions that, when executed by a processor, cause the processor to perform the method of claim 15.

26. A digital device comprising:
an antenna;
a cellular radio configured to transmit and receive data via the antenna according to a cellular communications standard;
a touch-sensitive display;
a memory configured to store instructions; and
a processor configured to execute the instructions to detect an incoming call through the cellular radio, to generate a notification of the incoming call, to recognize when a user pays attention to the touch-sensitive display, to determine the caller information to be displayed based on a time elapsed from the notification of the incoming call to when the user pays attention to the touch-sensitive display, and to dynamically display the caller information on a call-waiting screen of the touch-sensitive display.
